(19) United States
(12) Patent Application Publication
(10) Pub. No.: US 2009/0246744 A1
(43) Pub. Date: Oct. 1, 2009

(54) METHOD OF READING INSTRUCTION

(75) Inventors: Robert M. Lofthus, Webster, NY (US); Kristine A. German, Webster, NY (US); Frederique Segond, Grenoble (FR); Tracy Holloway King, Mountain View, CA (US); Marilyn Whalen, San Francisco, CA (US); Luke Plurkowski, Antioch, CA (US); Margaret Helen Szymanski, Santa Clara, CA (US); Qingfeng Huang, San Jose, CA (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignees: Xerox Corporation, Norwalk, CT (US); Palo Alto Research Center Incorporated, Palo Alto, CA (US)

(21) Appl. No.: 12/054,824

(22) Filed: Mar. 25, 2008

(51) Int. Cl. G09B 17/00

(52) U.S. Cl. 434/169; 434/178; 715/200; 434/322

(57) ABSTRACT

A method of automatically generating personalized text for teaching a student to learn to read. Based upon inputs of the students reading ability/level, either from a self assessment or teacher input and input of personal data, the system automatically searches selected libraries and chooses appropriate text and modifies the text for vocabulary and topics of character identification of personal interest to the student. An optional function of previewing by one of the student's teacher, parent or advocate is included. The system generates a local repository of generated text associated with a particular student.

### BACKGROUND

The present disclosure relates to techniques or methods of providing text for students first learning to read, especially in early childhood or later in life, e.g., learning English as a second language. With respect to teaching reading early in childhood, traditionally, texts have been prepared that were graduated in difficulty or challenge level and combined predictable elements with phonetically regular words. Such texts have been designed to achieve progress in the student's decoding skills; and, the story text could only be decoded if the speech sound-letter correspondences in all the words in that text had been taught prior to the introduction of the text to the student. This requires that the student be taught explicitly all the speech sound-letter correspondences necessary to decode or read the words in the text before the child encounters these words in a text.

In teaching children to read, it has been found that text with a strong instructional design provides for repeated exposure to high frequency words particularly those that rhyme, such as, dog, log, bog, and then build toward the less common, less regular and more complex words.

Another significant factor in designing text for beginning readers is accessibility which considers both the degree of decoding demands placed on the reader to recognize words in the text and the support surrounding the words which assists the reader with identification, fluency and comprehension. At the earliest levels, accessibility may require placing fewer decoding demands on the reader while providing more support through predicted features. At higher levels, the decoding demands may be increased while the amount of support offered through predictable features is decreased. Decodability relates to the word level and reflects the use of high frequency words as well as words that are phonetically regular. Predictability refers to the surrounding linguistic and design support for the identification of difficult words such as those which rhyme or through picture clues or repeated phrases.

Text which has engaging qualities can ignore issues of content and motivation and draw on a conception of reading that emphasizes the psychological and social aspects of engaging text that is designed to be interesting, relevant and exciting to the reader.

Heretofore, the content of text for beginning readers has been, at least for the mass published texts designed for learning to read, basically a “one-story-fits-all” arrangement in that the content or story line of each of the readers is the same for all students. Therefore, it has long been desired to provide a way of generating text for teaching reading that addresses the need for individualized engaging qualities of the text and further addresses the concern for the change in the engaging qualities which would appeal to the student over time.

### BRIEF DESCRIPTION

The present disclosure provides a way of automatically generating text for teaching a student to read and particularly for teaching reading early in childhood, which addresses the above described problems and not only changes the level of difficulty of the text based upon the student's learning ability at the particular point in time but also addresses the need for generating text with engaging qualities. The method disclosed herein begins with the input of information which may be obtained from the student's teacher, a parent, or advocate, or by a self-administered assessment to obtain an estimate of the student's present reading ability/level. The student is also queried for personal information regarding preferences, hobbies, interests and other personal data which provide a basis for the machine program to automatically search for, locate and modify reading items to address the student's reading ability and provide engaging qualities based upon the personal information supplied.

The method of the present disclosure provides for automatically modifying the located text to change sentence structure and/or vocabulary, add auxiliary hints, annotate with text or graphics, substitute personal data for a protagonist or other character and alter the thought, style or graphics associated with the text. The presently disclosed method provides for, at any time during the student's engagement with the program, querying the student, or the student's proxy, as to whether the student is ready for additional vocabulary words; and, the program may generate new text to include additional vocabulary words and even provide for marginal notations and hints with respect to such new words. The program automatically generates a local repository of text implementation for each student.

The present method thus provides for obtaining and personalizing text for a student learning to read based upon inputs as to the student's present reading level/ability and personal interests which are then used to automatically modify existing text to customize it for the individual student.

### BRIEF DESCRIPTION OF THE DRAWINGS

FIG. 1 is a block diagram of a system for a student to use to automatically generate text for teaching reading; and

FIGS. 2a, 2b, 2c and 2d comprise a block flow diagram or flow chart of the presently disclosed method employed in the system of FIG. 1.

### DETAILED DESCRIPTION

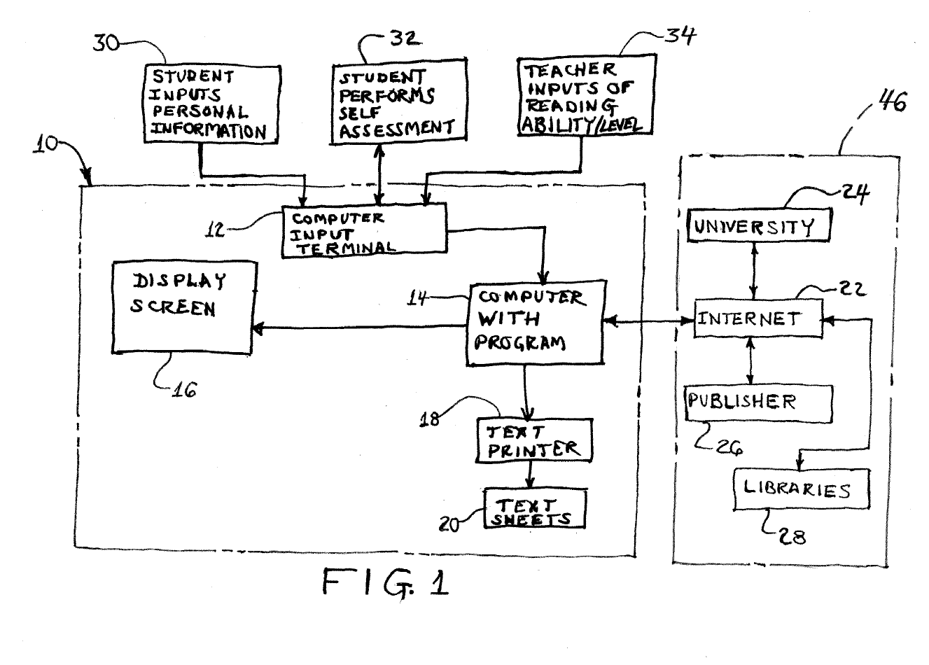

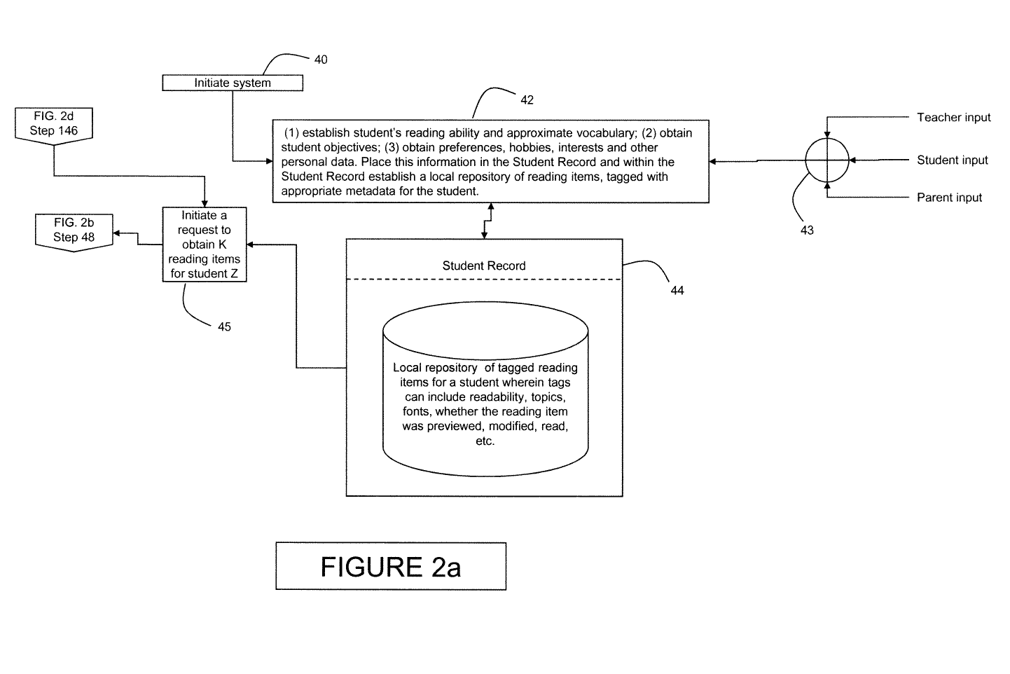

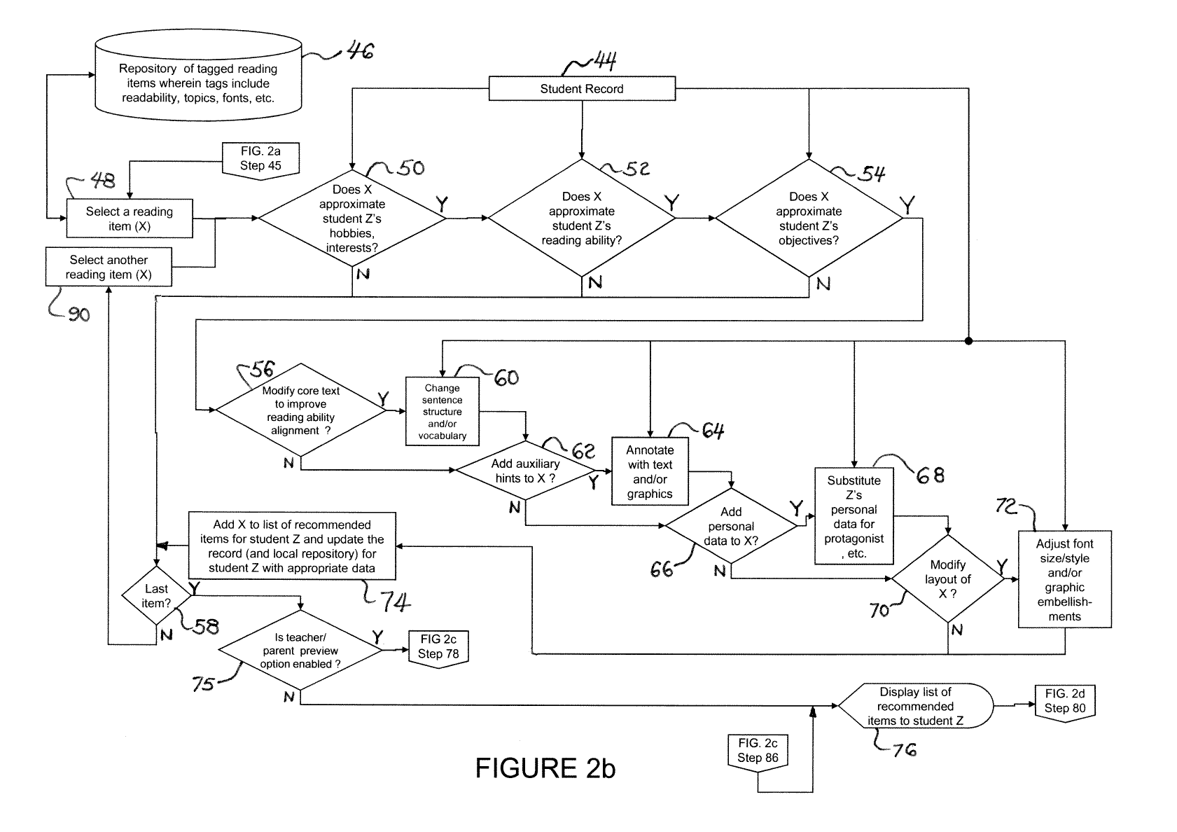

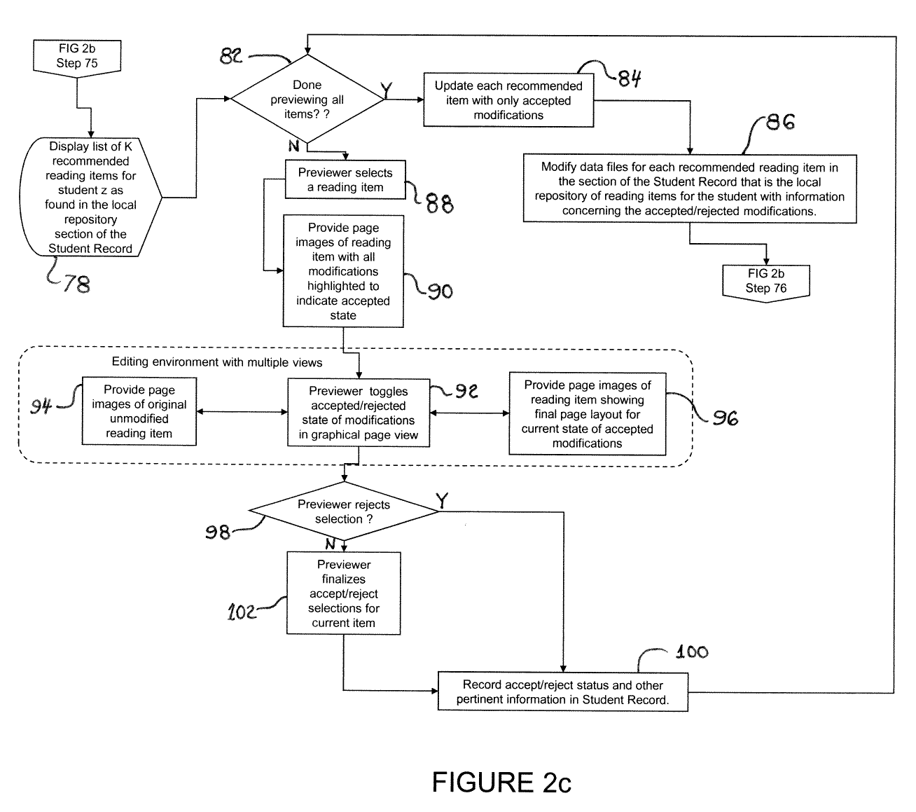

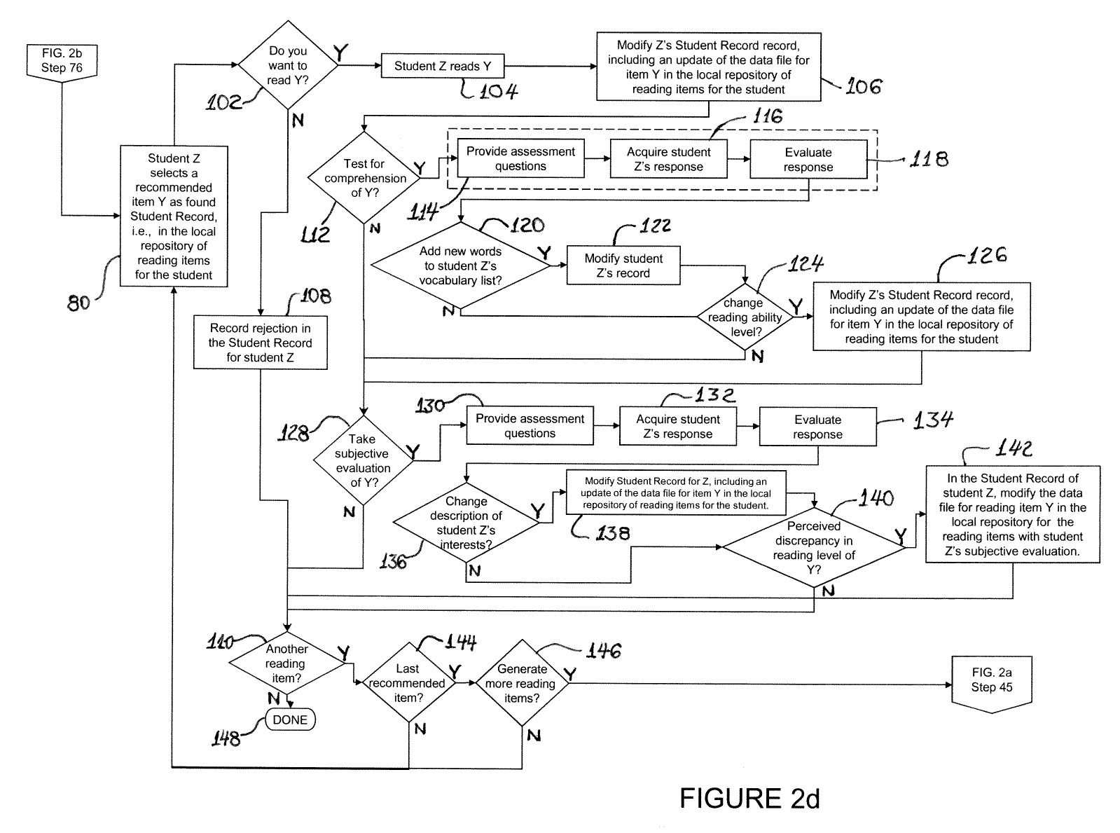

Referring to FIG. 1, the system is indicated generally at 10 and includes a computer input terminal 12 connected to a computer 14 which is loaded with the software or program of the present disclosure which outputs to a display screen 16 and also to a text printer 18 for printing text on individual sheets 20. In an alternative system embodiment, not shown, the software or program of the present disclosure resides remotely from the student as an internet application. The computer 14 is connected to the internet as indicated at 22 through which may access through prior arrangement, as for example by subscription, various sources such as a university 24, a publisher's database 26 or private libraries 28 of selected material. It will be understood that other particularized sources may be arranged for internet connection to the computer 14 as desired by the entity involved in teaching the student to learn to read, such as, for example, teacher generated or recommended text material. It will be further understood that open sources of beginning reading texts may also be accessed through the internet. Collectively, the sources comprise a repository 46 identified by dashed outline in FIG. 1 and solid outline in FIG. 2b.

The computer input terminal is intended to receive information relating to the student either from student personal information input at 30, from the student performing a self-assessment subroutine at 32 or inputs from a teacher or parent of information relating to the student's known reading ability/level at 34.

Referring to FIG. 2a, the initial portions of a program for computer 14 of FIG. 1 are shown in which the system is initiated at step 40 such as by the student engaging the computer input terminal 12; and, upon initiation proceeds to step 42 wherein the student's reading ability and vocabulary are established by inputs which may be from the teacher, the student performing a self-assessment subroutine on the computer, or from parent or student's advocate input as seen at summing junction 43. At step 42, the student also inputs personal objectives, preferences, hobbies, interests and other personal data; and, the system then proceeds to step 44 and creates a student record in the program. Captured personal information may also include information on the student's vision and primary language and concurrent studies.

The system is operable to automatically access through the internet any of the sources 24, 26, 28 as indicated in FIG. 1. At step 42, the system concurrently proceeds to make entries in a local repository portion of the student record wherein the information is tagged, for example, as to topic, readability and whether the item has been read, reviewed, modified and the like to facilitate automatic retrieval according to desired criteria.

Referring to FIG. 2b, upon initiation of a request to obtain appropriate reading items “K” for a particular student “Z,” the system selects a reading item at step 48 from the repository 46 which has the text items contained therein arranged with meta tags for enabling selected searching thereof, such as by reading level, topics and font for example. The system then proceeds with a series of queries the first of which is indicated at step 50 in which the system determines whether the selected material includes the hobbies or interests of the student from record 44. The determination can be made with an algorithm that executes a threshold comparison of student interests and reading item metadata, such as key words or subject listing. Alternatively, an algorithm that dynamically assigns a correlation value of the reading item text and the list of student interests and making a threshold comparison may be employed. In either case, default lower bound and upper bound thresholds are part of the student's record and can be adjusted by the student or the student's teacher, parent or advocate. If the determination at step 50 is affirmative, the system proceeds to step 52 and inquires as to whether the selected text approximates the student's reading ability obtained from step 44; and, if the determination at step 52, which may be based on either a metadata comparison or a dynamic evaluation of the text, is affirmative, the system proceeds to step 54 and asks whether a selected text includes the student's objectives from the student's record 44 at step 34. If the determination at step 54 is affirmative, which may be based on either a metadata comparison or a dynamic evaluation of the text, the system then proceeds to step 56 to inquire whether the text is to be modified to improve reading ability.

At step 56, the determination is based on either a predetermined or dynamically determined range of reading level over which the core text can be adapted.

If, however, the determination at any one of steps 50, 52 or 54 is negative, the system then proceeds to step 58 to inquire if this is the last item.

Alternatively at step 56, an affirmative response causes the system to proceed to step 60 and yields the best achievable match with respect to sentence structure and vocabulary. The operation of changing sentence structure and/or vocabulary at step 60 also receives inputs from the student record 44. Synonym substitution may be employed as a straightforward method to change the level of vocabulary in the selected text to better match the reading goal, e.g., the number or percentage of new words introduced in the selected text. This is made possible by the use of synonym lists. See for example: http://www.synonym.com/synonyms/ or http://wordnet.princeton.edu. With respect to changing sentence structure consider the following example. JOHN LEFT THE HOUSE AND WENT TO THE STORE. Using Natural Language Processing (NLP), it is determined that John is the subject of the second clause and that this is a coordinate structure. Thus, the original sentence can be broken into: JOHN LEFT THE HOUSE. JOHN WENT TO THE STORE. If desired, a decision step to check the modifications given above may be added for the cases of teacher/parent/student advocate. Additionally added vocabulary may be automatically highlighted and in color, if desired. The system then proceeds to step 62 and enquires as to whether auxiliary hints are to be added to the modified text. If the determination at step 56 is in the negative, the system proceeds directly to step 62. If the determination at step 62 is affirmative, the system proceeds to step 64 and annotates the text with additional text and/or graphics. Inputs from the student record 44 may also be received at step 64. The system then proceeds to step 66 and determines whether or not the text is amenable to the use of personal data to enhance the engaging qualities of the text. If the determination at step 66 is affirmative, the system proceeds to step 68 to substitute personal data obtained from the student's record 44 for the protagonist or other characters of the text. Inputs from the student record 44 may also be received at step 64. However, if the determination of step 62 is negative, the system proceeds directly to step 66.

From step 68 the system proceeds to step 70 to enquire as to whether the layout chosen reading item X is to be modified; and, if the determination at step 70 is affirmative, the system proceeds to step 72 to adjust the font style, size and/or graphic embellishments. Inputs from the student's record 44 may also be received at step 72. If the determination at step 66 is negative, the system proceeds directly to step 70. From step 72 the system proceeds to step 74 to add the text of item X from step 72 to the list of recommended items for this particular student “Z.” At step 74, the student's record 44 and local repository portion thereof are also updated with relevant data for the particular student “Z.” If the determination from step 70 is negative, the system proceeds directly to step 74.

If the determination at step 58 is affirmative, the system proceeds to step 75 and asks whether a preview option has been enabled for preview by any of an advocate, parent or teacher. If the determination at step 58 is negative, the system proceeds to step 90 to select another text for reading item “X.” The criteria for Last item at step 58 can be determined either by exhausting the items in the repository 46 or by reaching a maximum number of selections as set in the student's record.

If the preview function has been enabled at step 75, the system proceeds to FIG. 2c step 78 and displays to the previewer, which may be at a location remote from the student, a list of “K” recommended reading items for the student “Z.” If the preview function has not been enabled at step 75, the system proceeds directly to step 76 and displays the list to the student.

The system proceeds from step 76 to FIG. 2d at step 80 and the student selects a recommended item whereupon it proceeds to step 102 and enquires of the student whether the student wishes to read the item.

Referring to FIG. 2c, the system proceeds from step 78 where the previewer has reviewed the list of K recommended reading items for the student Z to step 82 where the question is asked whether previewer is finished previewing all the items in the list; and, if the determination at step 82 is affirmative, the system proceeds to step 84 and updates each recommended item with only the accepted modifications. From step 84, the system proceeds to step 86 and modifies the data files for each recommended reading item in the local repository portion of the student record 44 with information concerning the accepted/rejected modifications. The system then proceeds to step 76 (see FIG. 2b).

If however, the determination at step 82 is negative, the previewer selects a reading item at step 88 and the system proceeds to step 90 and provides pages of the reading item with all the modifications highlighted to indicate the accepted state. The system then proceeds to step 92 where the previewer toggles the accepted/rejected state of the modification in graphical page view between page images of the original unmodified reading item as denoted by reference numeral 94 in the block to the left of step 92 and the page images of the reading item showing the final page layout for the current state of accepted modifications as indicated by reference numeral 96 in the block to the right of step 92. With the editing review of step 92 completed, the system proceeds to step 98 and asks whether the previewer rejects the selection. If the question of step 98 is answered in the affirmative, the system proceeds to step 100 and records the accept/reject status and other pertinent information in the student's record 44 and in the local repository reading items for the student in the record 44 and returns to step 82. If the question in step 98 is answered in the negative, the system proceeds to step 102 and the previewer finalizes the accepted/rejected selections for the current item and the system proceeds to step 100.

Referring to FIG. 2d, the system at step 80 enables the student to select a recommended item Y as found in the local repository of reading items for the student in the student's record 44 and proceeds to step 102 and asks the student if he or she wishes to read Y. If the student responds in the affirmative and proceeds to read Y at step 104, the system proceeds to step 106 and modifies the student's record 44 and the data file for item Y in the local repository of reading items for the student in the student's record 44.

If the student responds in the negative at step 102, the system proceeds to step 108 and records the rejection in the student record and the local repository of reading items for student Z and then proceeds to step 110. From step 106, the system proceeds to step 112 and asks if a test for comprehension is to be given. If the question in step 112 is answered in the affirmative, the system proceeds to step 114 and provides a series of assessment questions and acquires the particular student Z's response at step 116 and proceeds to evaluate the response at step 118. The system then proceeds to step 120 and asks whether new words should be added to the student Z's vocabulary list. If the determination at step 120 is affirmative, the system proceeds to step 122 and modifies the student Z's record and then proceeds to step 124. If the determination at step 120 is negative, the system proceeds to step 124 and asks whether to change the reading ability level. If the query at step 124 is answered in the affirmative, the system proceeds to step 126 and modifies the record for student Z and updates the data file for item Y in the local repository reading items in the student's record 44. The system then proceeds to step 128.

If the determination at step 112, however, is negative, the system proceeds directly to step 128. If the determination at step 124 is answered in the negative, the system also proceeds to step 128.

At step 128, the determination is made whether to take a subjective evaluation of Y; and, if the determination is in the affirmative, the system proceeds to step 130 and provides assessment questions to the student Z and acquires the student's responses thereto at step 132 and then evaluates the responses at step 134. The system then proceeds to step 136 and inquires as to whether to change the description of student Z's interest. If the answer to the query at step 136 is affirmative, the system proceeds to step 138 and modifies the student's record for Z and updates the data file for item Y in the local repository of reading items for the student and then proceeds to step 140. If the determination at step 136 is negative, the system proceeds directly to step 140.

At step 140, the question is asked whether there is a perceived discrepancy in the reading level of Y. If the determination at step 140 is affirmative, the system proceeds to step 142 and modifies the data file for reading item Y in the local repository of student's reading items in the record 44 with student Z's subjective evaluation. The system then proceeds to step 110.

If the determination at step 138 or step 140 is negative, the system proceeds directly to step 110.

At step 110, the system inquires as to whether another reading item is desired; and, if the answer is affirmative, the system proceeds to step 144 and asks if this is the last recommended item and, if the response is affirmative, the system proceeds to step 146 and asks whether to generate more reading items. If the answer at step 146 is affirmative, the system proceeds to FIG. 2a to step 45. If the query at step 110 is negative, the program is finished and the system stops at step 148. If the determination at either step 144 or step 146 is negative, the system returns to step 80.

The present disclosure has described hereinabove a system or method of automatically generating customized text for a student learning to read based upon inputs either from a self-administered self-assessment test or from a teacher, parent or advocate regarding the student's reading level/ability; and, from inputs from the student regarding personal interests, hobbies, and other personal information to generate customized text with personal information substituted for names of characters and/or modified sentence structure and vocabulary to closely approximate the student's reading level/ability. The system automatically generates the customized personalized text for the student learning to read by accessing, a local repository which may have text derived via the internet, from prearranged databases of textural material comprising a repository created for the purpose of teaching students to learn to read.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of automatically generating text for teaching reading comprising:
(a) obtaining selected personal information items from a student;
(b) obtaining information relating to the student's reading ability/level;
(c) automatically searching certain digitally available text sources related to teaching reading and automatically selecting text based upon student's interest obtained from (a);
(d) automatically selecting text from those selected in (c) with readability corresponding with student's reading ability/level obtained in (b);
(e) automatically modifying the selected text based on the personal information (a) and automatically forming customized text for the student; and,
(f) printing/displaying the customized text for the student to read.

2. The method defined in claim 1, wherein the step of obtaining personal information items includes obtaining items of the student's interest.

3. The method defined in claim 1, wherein the step of providing information relating to the student's reading ability/level includes obtaining information from an assessment of reading ability by the student's teacher.

4. The method defined in claim 1, wherein the step of obtaining information relating to the student's reading ability/level includes obtaining an estimate from a student self-administered test.

5. The method defined in claim 1, further comprising highlighting words above the student's decodable level.

6. The method defined in claim 5, wherein the step of highlighting includes printing/displaying the words in color.

7. The method defined in claim 1, wherein the step of automatically searching includes searching the internet.

8. The method defined in clam 1, wherein the step of automatically searching certain digitally available sources includes searching topically indexed sources.

9. The method defined in claim 1, wherein the step of modifying the selected text includes incrementing the reading level of the selected text.

10. The method defined in claim 1, wherein the step of modifying the selected text includes decrementing the reading level of the selected text.

11. The method defined in claim 1, wherein the step of obtaining selected personal information includes providing the student's reading objectives.

12. The method defined in claim 11, wherein the step of providing reading objectives includes inputting mandated requirements.

13. The method defined in claim 11, wherein the step of providing the student's reading objectives includes providing formal remediation requirements.

14. The method defined in claim 1, wherein the step of obtaining information relating to the reading level/ability includes obtaining an estimate from a student self administered test.

15. The method defined in claim 1, wherein the step of obtaining personal information includes obtaining information relating to subject matter of the student's interest.

16. The method defined in claim 1, wherein the step (d) of selecting text includes selecting text within a predetermined variance of the student's reading ability.

17. The method defined in claim 1, wherein the step of obtaining information relating to the student's reading ability/level includes obtaining an assessment from the student's teacher.

18. The method defined in claim 13, wherein the step of obtaining from the student's teacher information relating to student's reading ability/level includes obtaining limitations on vocabulary.

19. The method defined in claim 1, wherein the step of automatically modifying the selected text includes previewing of the selected text by one of the student's teacher, parent and advocate.

20. The method defined in claim 1, further comprising generating a localized repository of the customized text for a particular student.

21. A method of automatically generating text for teaching reading comprising:
(a) capturing selected personal information items relating to a student;
(b) obtaining from the student's teacher information relating to the student's reading ability/level;
(c) generating a composite text criteria for the student from steps (a) and (b);
(d) automatically searching certain available digital sources and automatically identifying appropriate reading items approximating the composite text criteria;
(e) automatically selecting text from items identified in (d) according to predetermined rules; and
(f) automatically modifying each selected text based on information from one of (a) and (b) and automatically generating customized reading text.

22. The method defined in claim 21, wherein the step of modifying each selected item includes including information from (a) and (b).

23. The method defined in claim 21, wherein the step of forming customized text includes previewing the selected text by one of the student's teacher, parent and advocate.

24. The method defined in claim 21, wherein the step of generating customized reading text includes, at the student's request, selecting text items that use words not in the student's reading level/ability and adding marginal notation relating to such words.

25. The method defined in claim 21, wherein the step of capturing selected personal information includes obtaining information on the student's interests.

26. The method defined in claim 21, wherein the step of capturing selected personal information items includes capturing information relating to the student's primary language.

27. The method defined in claim 21, wherein the step of identifying includes identifying topics of personal interest in concurrent studies.

28. The method defined in claim 21, wherein the step of obtaining information relating to needs for special letter/character size.

29. The method defined in claim 21, wherein the step of capturing includes obtaining information on the student's vision.

30. The method defined in claim 21, wherein the step of obtaining includes information relating to the student's text length preference.

31. The method defined in claim 21, wherein the step of modifying includes substitution of graphics.

32. The method defined in claim 21, further comprising ranking the selected text items according to closeness of match with the reading ability and vocabulary.

33. The method defined in claim 21, wherein the step of searching includes searching the internet.

34. The method defined in claim 21, wherein the step of selecting includes selecting text items that approximate the reading ability and vocabulary within a predetermined variance.

35. The method defined in claim 21, wherein the step of generating customized reading text includes adding marginal hints.

36. The method defined in claim 21, wherein the step of modifying includes changing sentence structure.

37. The method defined in claim 21, wherein the step of modifying includes changing vocabulary based upon (a) and (b).

38. The method defined in claim 21, wherein the step of modifying includes substituting named individuals from the information obtained in step (a) into the text.
